(19) United States
(12) Patent Application Publication
(10) Pub. No.: US 2006/0071899 A1
(43) Pub. Date: Apr. 6, 2006

(54) Apparatus and method for reducing power consumption by adjusting backlight and adapting visual signal

(75) Inventors: Nae Hyuck Chang, Seoul (KR); Jae Joon Kim, Daejon (KR); Je Ho Nam, Seoul (KR); Jin Woo Hong, Daejon (KR); Jin Woong Kim, Daejon (KR); Nam Ik Cho, Seoul (KR); Hyoung Joong Kim, Seocho-gu (KR); Man Bae Kim, Gangwon-do (KR); Rin Chul Kim, Seoul (KR); Hae Kwang Kim, Seoul (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(73) Assignee: Electrics and Telecommunications Research Insitute, Daejon (KR)

(21) Appl. No.: 10/511,238

(22) PCT Filed: Apr. 25, 2003
(86) PCT No.: PCT/KR03/00849

§ 371 Date: Sep. 19, 2005

(30) Foreign Application Priority Data
Apr. 26, 2002 (KR) 10-2002-0023151

(51) Int. Cl. G09G 3/36

(52) U.S. Cl. 345/102

(57) ABSTRACT

Backlight intensity is adjusted in a terminal. An adaptation apparatus transmits a visual signal after optimizing brightness or contrast of the visual signal based on the backlight intensity information which is related to the adjusted backlight intensity, so that the user can enjoy digital item with reduced power consumption of the terminal.

### TECHNICAL FIELD

The present invention relates to an apparatus and method for reducing power consumption by adjusting the intensity of a liquid crystal display (LCD) backlight and adapting visual signals; and, more particularly, to an apparatus and method for reducing the power consumption of an end user terminal provided with a thin film transistor-liquid crystal display (TFT-LCD) panel by adjusting the luminance or intensity of the LCD backlight, and minimizes the change in the quality of video by adapting the brightness or contrast of visual signals.

### BACKGROUND ART

Thin film transistor-liquid crystal display (TFT-LCD) is a display device widely used in user terminals, such as computers, e.g., laptops, desktops, workstations and mainframe computers, personal digital assistants (PDAs), and data processing or signal processing systems, e.g., wireless communication mobile stations. Differently from cathode ray tube (CRT), plasma display panel (PDP) and filed emission display (FED), LCD is non-luminous, which means LCD cannot be used in dark places.

Therefore, the LCD requires a backlight necessarily, which a lighting apparatus that gives an LCD panel plane lights with uniform brightness is a core element of an LCD device. It maintains the luminance of the lights on the entire LCD panel uniformly and provides visual signals in high luminance.

However, the amount of power consumed by a backlight lamp and an inverter circuit for driving the backlight occupies around 30% of the entire power consumption of an end user terminal. In short, the use of a backlight heightens the power consumption of a user terminal. Therefore, the backlight needs be adjusted to reduce the consumption of power in a user terminal, particularly in a portable terminal using a limited power source.

If the backlight is set dim or turned off, the amount of power consumption is reduced. However, a backlight of a transmissive TFT-LCD cannot be turned off. Only a trans-reflective TFT-LCD can be operated without the backlight. Without compensating visual signals properly, the quality of the visual signals is deteriorated seriously even at a little decrease of the backlight intensity. If the luminance of the backlight is reduced a little, the user feels uncomfortable to the video of the visual signal. That is, even a little dimming of the backlight makes the user feel tired easily, and much dimming of the backlight makes the video hardly recognized.

Therefore, compensation for the damage on the luminance caused by the dimming of the backlight is required necessarily in order not to degrade the quality of visual signals while reducing the power consumption of the end user terminal. The compensation is performed by increasing the brightness or contrast of the visual signals. If the improvement of the luminance and contrast of visual signals is increased, the backlight intensity can be reduced.

Meanwhile, a Motion Picture Experts Group (MPEP) has suggested a new standard working item, Digital Item Adaptation (DIA). Digital Item (DI) stands for a structured digital object with standard representation, identification and metadata, and DIA means a process for generating an adapted DI by modifying a DI in a resource adaptation engine and/or descriptor adaptation engine.

Here, the resource means an item that can be identified individually, such as video or audio clips, and image or text items. It may stand for a physical object, too. Descriptor means information related to the components or items of a DI. Also, a user is meant to include all the producer, rightful person, distributor and consumer of the DI. Media resource means a content that can be expressed digitally directly. In this specification, the term ‘content’ is used in the same meaning as DI, media resource and resource.

Conventional technologies have a problem that they cannot provide a single-source multi-use environment where one visual signal can be adapted to and used in different usage environments by using backlight intensity information of each end user terminal, i.e., a usage environment for consuming a visual signal.

Here, ‘a single source’ denotes a content generated in a multimedia source, and ‘multi-use’ means that various end user terminals consume the ‘single source’ adaptively to each of the usage environment.

Single-source multi-use is advantageous because it can provide diversified contents with only one content by adapting the only one content to different usage environments. Therefore, it can reduce the high cost for producing and transmitting a plurality of contents to match visual signals to various levels of backlight intensity on the part of a content provider. On the content consumers' part, the single-source multi-use makes them consume a suitable content for an adjusted level of backlight intensity, when the backlight intensity of the end user terminal is adjusted.

Conventional technologies do not take the advantage of single-source multi-use environment even in a Universal Multimedia Access (UMA) environment that can support the single-source multi-use environment. That is, the conventional technologies transmit contents indiscriminately without considering the usage environment. This means that the user himself should establish the brightness or contrast of the visual signals to compensate for the damage in the luminance of visual signal, which is caused by the reduction of the backlight intensity in the end user terminal.

If a multimedia source provides a multimedia content in consideration of various usage environments to overcome the problem of the conventional technologies and support the single-source multi-use environment, much load is applied to the generation and transmission of the content.

### DISCLOSURE OF INVENTION

It is, therefore, an object of the present invention to provide an apparatus and method that can reduce the power consumption of an end user terminal having a liquid crystal display (LCD) panel by decreasing the backlight intensity of the end user terminal, and minimize the change in the quality of the visual signal by adapting the brightness or contrast of the visual signals.

In accordance with one aspect of the present invention, there is provided an apparatus for controlling a backlight of an LCD and processing videos, including: a generation unit for generating adjusted backlight intensity information to reduce the power consumption of an end user terminal provided with the LCD; and an adaptation unit for adapting the brightness and/or contrast of a visual signal based on the backlight intensity information and displaying the adapted visual signal on the LCD.

In accordance with one aspect of the present invention, there is provided a method for controlling a backlight of an LCD and processing videos, comprising the steps of: a) generating adjusted backlight intensity information to reduce the power consumption of an end user terminal provided with the LCD; and b) adapting the brightness and/or contrast of a visual signal based on the backlight intensity information and displaying the adapted visual signal on the LCD.

The apparatus and method of the present invention can reduce the backlight intensity of an end user terminal that consumes contents through an LCD, and adapt the pixel value of visual signals to the adjusted backlight intensity by increasing the brightness or contrast of the visual signals. This way, the power consumption of the end user terminal is reduced, and the user can hardly recognize the difference in the video quality because the brightness or contrast of the visual signals is increased, even if the backlight intensity is decreased.

Also, the apparatus and method of the present invention can provide a single-source multi-use environment where one content is adapted to and used in different usage environments. This is because a video adaptation apparatus adapts the brightness or contrast of the visual signals to the adjusted backlight intensity of the end user terminal and transmits the adapted visual signals to the end user terminal.

### BRIEF DESCRIPTION OF DRAWINGS

The above and other objects and features of the present invention will become apparent from the following description of the preferred embodiments given in conjunction with the accompanying drawings, in which:

FIG. 1 is a diagram illustrating the adjustment of backlight intensity and the adaptation of a visual signal in accordance with the present invention;

FIG. 2 is a block diagram describing a video adaptation apparatus for adapting the pixel value of a visual signal based on adjusted backlight intensity in accordance with an embodiment of the present invention;

FIG. 3 shows an example of phrasal descriptions expressing a structure of backlight intensity information based on extensible markup language Schema Description (XSD);

FIG. 4 is a diagram illustrating a process where an end user terminal transmits adjusted backlight intensity information to a node system provided with the video adaptation apparatus, and receives adapted visual signals in accordance with an embodiment of the present invention;

FIG. 5 is a diagram describing a process where the end user terminal provided with a video adaptation apparatus adjusts backlight intensity dynamically in accordance with another embodiment of the present invention; and

FIG. 6 is a flow chart depicting a video adaptation process performed in the video adaptation apparatus of FIG. 2.

### BEST MODE FOR CARRYING OUT THE INVENTION

Following description exemplifies only the principles of the present invention. Even if they are not described or illustrated clearly in the present specification, one of ordinary skill in the art can embody the principles of the present invention and invent various apparatuses within the concept and scope of the present invention.

The conditional terms and embodiments presented in the present specification are intended only to make understood the concept of the present invention, and they are not limited to the embodiments and conditions mentioned in the specification.

In addition, all the detailed description on the principles, viewpoints and embodiments and particular embodiments of the present invention should be understood to include structural and functional equivalents to them. The equivalents include not only the currently known equivalents but also those to be developed in future, that is, all devices invented to perform the same function, regardless of their structures.

For example, block diagrams of the present invention should be understood to show a conceptual viewpoint of an exemplary circuit that embodies the principles of the present invention. Similarly, all the flow charts, state conversion diagrams, pseudo codes, and the like can be expressed substantially in a computer-readable media, and whether or not a computer or a processor is described in the specification distinctively, they should be understood to express a process operated by a computer or a processor.

The functions of various devices illustrated in the drawings including a functional block expressed as a processor or a similar concept can be provided not only by using dedicated hardware, but also by using hardware capable of running proper software. When the function is provided by a processor, the provider may be a single dedicated processor, single shared processor, or a plurality of individual processors, part of which can be shared.

The apparent use of a term, ‘processor’, ‘control’ or similar concept, should not be understood to exclusively refer to a piece of hardware capable of running software, but should be understood to include a digital signal processor (DSP), hardware, and ROM, RAM and non-volatile memory for storing software, implicatively. Other known and commonly used hardware may be included therein, too.

In the claims of the present specification, an element expressed as a means for performing a function described in the detailed description is intended to include all methods for performing the function including all formats of software, such as a combination of circuits that performs the function, firmware/microcode, and the like. To perform the intended function, the element is cooperated with a proper circuit for performing the software. The present invention defined by claims includes diverse means for performing particular functions, and the means are connected with each other in a method requested in the claims. Therefore, any means that can provide the function should be understood to be an equivalent to what is figured out from the present specification.

Other objects and aspects of the invention will become apparent from the following description of the embodiments with reference to the accompanying drawings, which is set forth hereinafter. The same reference numeral is given to the same element, although the element appears in different drawings. In addition, if further detailed description on the related prior arts is thought to blur the point of the present invention, the description is omitted. Hereafter, preferred embodiments of the present invention will be described in detail.

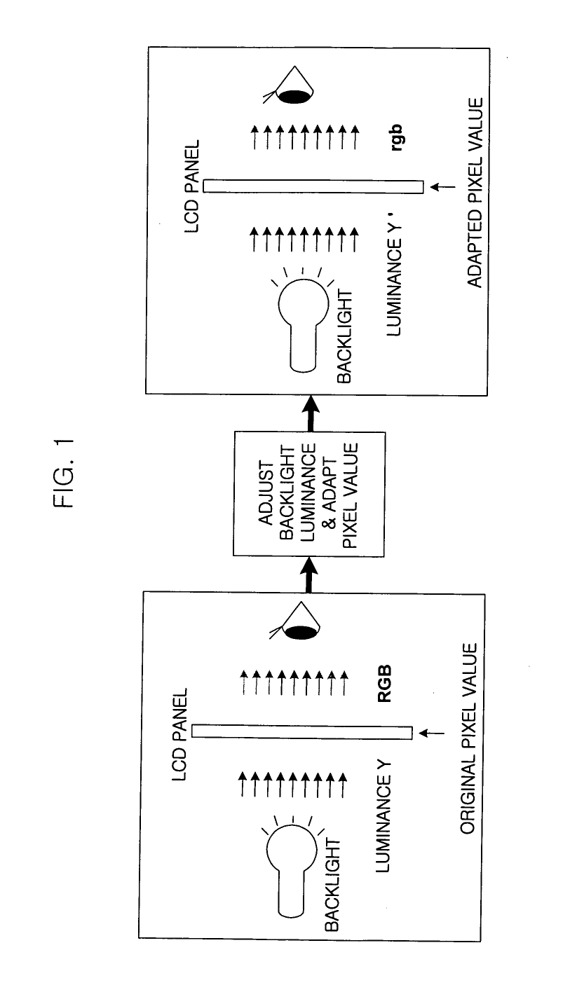

FIG. 1 is a diagram illustrating the adjustment of backlight intensity and the adaptation of a visual signal in accordance with the present invention.

Colors demanded by a visual signal are displayed, as backlight, which is a white light source, passes through a liquid crystal display (LCD) panel. The pixel value of the visual signal has information on how much and which lights should be transmitted among the lights that compose the white light source. When the backlight intensity is reduced, the LCD becomes dark. However, if the brightness or contrast of the visual signal is adjusted to the reduced backlight intensity through a video processing, a user can hardly recognize any difference between the original visual signal and the adjusted visual signal. That is, although the backlight intensity is decreased and the power consumption of an end user terminal is reduced, the quality of the visual signal is not deteriorated. This is because, when the luminance of the backlight is adjusted from the original value Y to a value Y′, the pixel value of the visual signal is adapted to the adjusted luminance from the original pixel value RGB to a value rgb so that there should be almost no difference between the visual signal recognized by the user by the pixel value RGB based on Y and the visual signal recognized by the user by the pixel value rgb based on Y′.

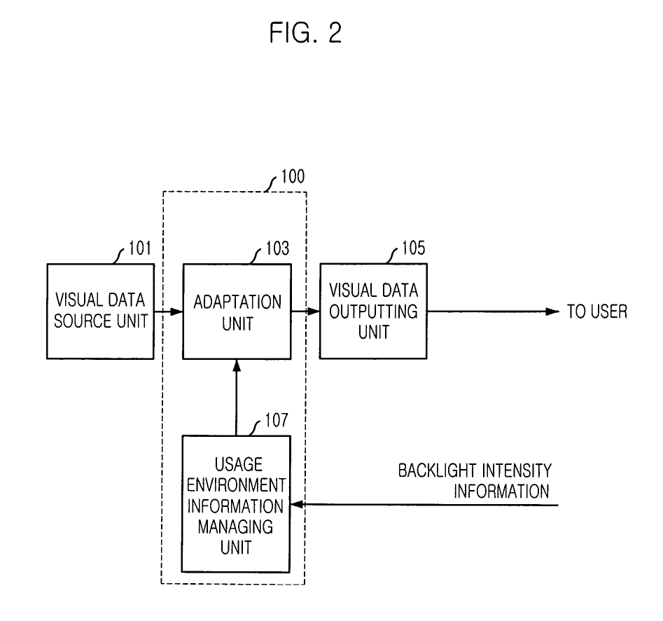

FIG. 2 is a block diagram describing a video adaptation apparatus for adapting the pixel value of a visual signal based on adjusted backlight intensity in accordance with an embodiment of the present invention. As shown in the drawing, the video adaptation apparatus 100 includes an adaptation unit 103, and a usage environment information managing unit 107. The video adaptation apparatus 100 may be provided to a video processing system.

A video processing system includes a computer provided with a LCD, such as laptop computers, notebook computers, desktop computers, workstations, mainframe computers and other types of computers. The video processing system further includes various data processing or signal processing systems, such as personal data assistants (PDAs) and wireless communication mobile stations.

Also, the video processing system may be any one among all the node systems that form a network path, i.e., a multimedia source node system, multimedia relay node system, and an end user terminal.

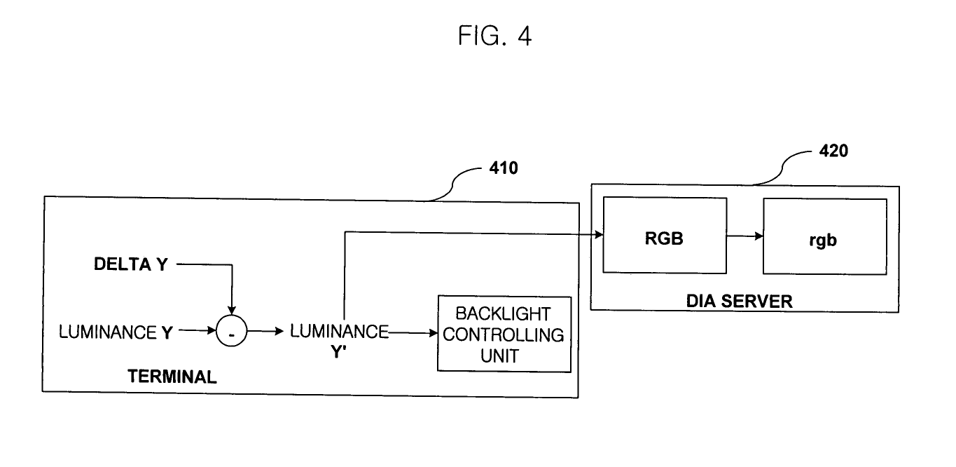

A visual data source unit 101 receives visual data generated from a multimedia source. The visual data source unit 101 may be included in the multimedia source node system, or in the multimedia relay node or the end user terminal that receives the visual data transmitted from the multimedia source node through wired/wireless network (see FIG. 4). Here, the visual data includes video data, images and graphics.

The adaptation unit 103 receives visual data from the visual data source unit 101, and adapts the visual data by adapting the pixel values of visual signals properly to the adjusted backlight intensity based on the backlight intensity information of the end user terminal, which is described in advance by the usage environment information managing unit 107.

The pixel values can be adapted to the adjusted backlight intensity by shifting an RGB value, controlling the brightness or contrast of a visual signal, warping histogram, warping histogram in a YUV space, or warping intensity in a Hue, Intensity and Saturation (HIS) space. YUV is an abbreviation used to indicate luminance signals and hue difference in a video system. Here, Y stands for a luminance signal, while U and V denote the center of two sub-carriers used in a phase alternate line (PAL) method. The hue difference signal of B-Y and R-Y is processed and used to modulate a PAL sub-carrier in the U and V axes.

Meanwhile, depending on a kind of pixel value to be controlled, the brightness/contrast of the visual signal can be controlled by adapting a pixel value of a visual signal after decoding compressed visual data, or by adapting only discrete cosine transform (DCT) coefficients of a compressed visual data.

If a visual signal has a small number of saturated pixels, a change in the brightness of the visual signal hardly distorts the original image. In this case, since the range of general change is small, small amount of power gain is expected.

In the mean time, change in the contrast of a visual signal, such as luminance histogram equalization, distorts the original image. However, if the colors of the original image do not matter, much more change can be made in the contrast.

More refined color histogram stretching can be made by controlling hue, saturation and intensity of the backlight. High-contrast color setting can be used for vision-handicapped persons in a personal computer (PC) window system.

The usage environment information managing unit 107 obtains adjusted backlight intensity information from the end user terminal, and then describes it in advance and manages it.

For example, a syntax of backlight intensity information is expressed based on extensible markup language Schema Definition (XSD), which is shown below.
<element name=“Backlight” type=“mpeg7: ZeroToone”/>

According to the above syntax, the backlight intensity has a value in a range from 0.0, a value indicating no backlight, to 1.0, a value indicating the maximum backlight intensity.

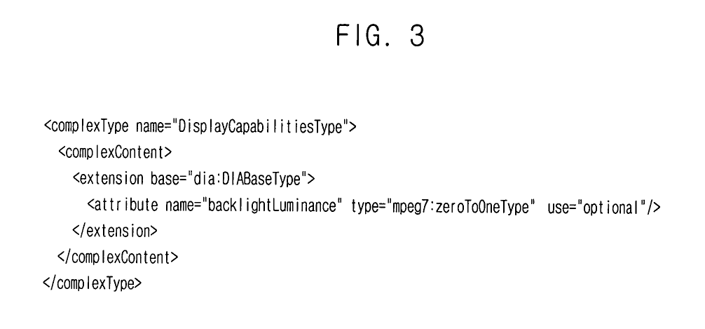

FIG. 3 shows an example of syntaxes expressing a structure of the backlight intensity information based on the XSD. Here, the backlight intensity information is included in a description information on the display capability of the end user terminal (‘DisplayCapabilitiesType’). Referring to FIG. 3, ‘backlightLuminance’ means the same as ‘backlight’ in the above syntax of backlight intensity information. It describes the amount of luminance of the display backlight. In short, the description of the backlight intensity used in the end user terminal having an LCD panel can be used to make the adaptation unit 103 improve the brightness or contrast of the visual signal and then transmit the adapted visual signal to the end user terminal. This way, the user can experience DI having undamaged quality under low backlight intensity.

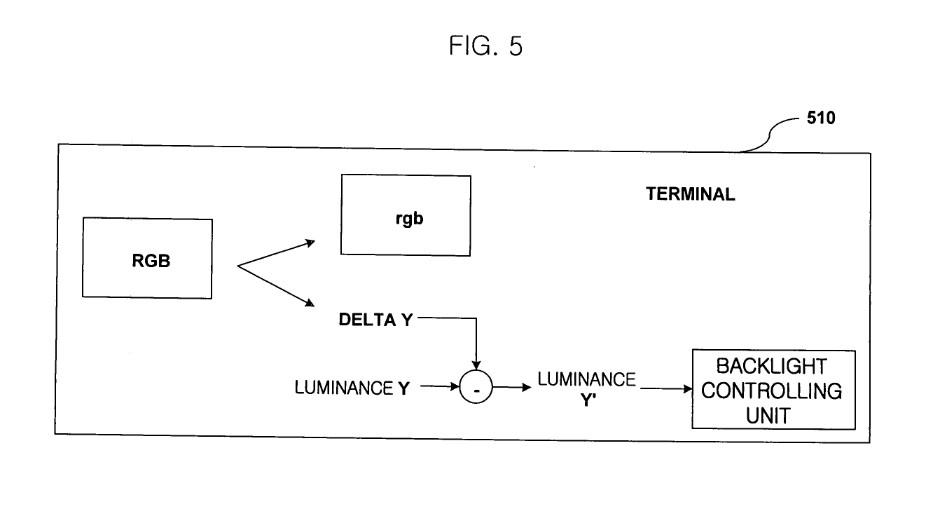

The backlight intensity information acquired from the end user terminal may be set by a user directly, or set by the end user terminal dynamically. In other words, the dynamically adjusted backlight intensity information can be obtained, as the end user terminal determines the reducible backlight intensity (delta Y) based on the RGB value, i.e., the information of the visual signal transmitted to the user end terminal (see FIG. 5).

A visual data outputting unit 105 outputs the visual data adapted by the adaptation unit 103. The outputted visual data can be transmitted to a video player of the end user terminal, or to a multimedia relay node system or an end user terminal through a wired/wireless network.

As described before, the video processing system including the video adaptation apparatus 100 may be a node system that forms a network path. For example, if the video adaptation apparatus 100 is provided to a multimedia source node system and operated, it should receive adjusted backlight intensity information from the end user terminal, adapt a visual signal to the adjusted backlight intensity of the end user terminal that consumes a content through LCD, and transmit the adapted visual signal to the end user terminal. If the end user terminal uses a video on demand (VOD) service, the adjusted backlight intensity information of the end user terminal is transmitted to a VOD server, and a visual signal with an adapted brightness or contrast is received.

FIG. 4 is a diagram illustrating a process where an end user terminal transmits adjusted backlight intensity information to a node system, i.e., DIA server 420, which is provided with a video adaptation apparatus 100, and receives adapted visual signals in accordance with an embodiment of the present invention. As shown in the drawing, when the luminance of the backlight is reduced by delta Y from the original value Y to a value Y′ in an end user terminal 410, the end user terminal 410 transmits the information on backlight luminance change to the node system 420, and receives a visual signal adapted to the adjusted backlight luminance from the node system 420.

FIG. 5 is a diagram describing a process where the end user terminal 510 having a video adaptation apparatus adjusts backlight intensity dynamically in accordance with another embodiment of the present invention. Referring to this drawing, the backlight intensity is reduced to a minimum value, as the end user terminal 510 determines the reducible backlight intensity (delta Y) based on the information of the visual signal, i.e., an RGB value. Accordingly, the pixel value of the visual signal is adjusted from RGB to rgb.

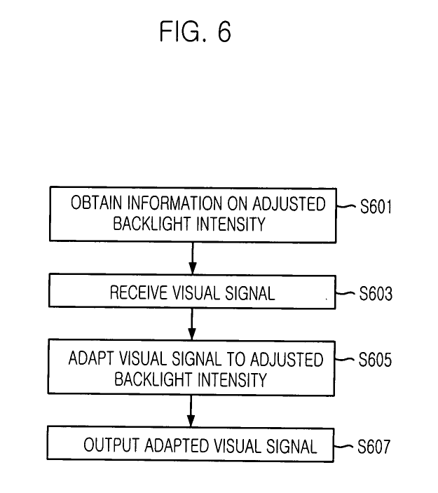

FIG. 6 is a flow chart depicting a video adaptation process performed in the video adaptation apparatus 100 of FIG. 2. Referring to this drawing, at step S601, the process of the present invention begins, as the usage environment information managing unit 107 acquires information on adjusted backlight intensity from the final user terminal and describes it in advance.

Subsequently, at step S603, the visual data source unit 101 receives the visual signal. Then, at step S605, the adaptation unit 103 adapts the received visual signal to the adjusted backlight intensity of the end user terminal by using the adjusted backlight intensity information, which is described at the step S601. At step S607, the visual data outputting unit 105 outputs the visual signal adjusted at the step S605.

As described above, the technology of the present invention makes a user experience visual signals with undamaged quality by adapting the luminance or contrast of a visual signal into high-level based on the adjusted backlight intensity information to reduce the power consumption of the end user terminal and transmitting the adapted visual signals to the end user terminal.

It can provide a single-source multi-use environment by adapting a visual signal to different backlight intensities based on the adjusted backlight intensity information and then transmitting the adapted visual signal to the end user terminal to reduce the power consumption of the end user terminal.

While the present invention has been described with respect to certain preferred embodiments, it will be apparent to those skilled in the art that various changes and modifications may be made without departing from the scope of the invention as defined in the following claims.

What is claimed is:

1. An apparatus for controlling a backlight of a liquid crystal display (LCD) and processing visual signals, comprising:
a generation means for generating on adjusted backlight intensity information to reduce the power consumption of an end user terminal having the LCD; and
an adaptation means for adapting brightness and/or contrast of the visual signal based on the backlight intensity information and displaying the adapted visual signal on the LCD.

2. The apparatus as recited in claim 1, wherein if the backlight intensity information indicates that the backlight is adjusted from the original luminance value Y to a value Y′, the adaptation means adapts the original pixel value of the visual signal proper for the original luminance value Y to a pixel value proper for the adjusted luminance value Y′.

3. The apparatus as recited in claim 1, wherein the adaptation means is included in a system that provides the visual signal to the end user terminal.

4. The apparatus as recited in claim 1, wherein the generation means for generating adjusted backlight intensity information controls the backlight intensity dynamically according to information on the visual signal displayed on the LCD.

5. A method for controlling a backlight of an LCD and processing visual signals, comprising the steps of:
a) generating adjusted LCD backlight intensity information to reduce the power consumption of an end user terminal having the LCD; and
b) adapting brightness and/or contrast of the visual signal based on the backlight intensity information and displaying the adapted visual signal on the LCD.

6. The method as recited in claim 5, wherein if the adjusted backlight intensity information indicates that the backlight is adjusted from the original luminance value Y to a value Y′, the original pixel value of the visual signal proper for the original luminance value Y is adapted to a pixel value proper for the adjusted luminance value Y′ in the step b).

7. The apparatus as recited in claim 5, wherein the step b) is performed in a system that provides the visual signal to the end user terminal.

8. The apparatus as recited in claim 5, wherein the step a) includes the step of:
a1) adjusting the backlight intensity dynamically according to information on the visual signal displayed on the LCD.
